(19) United States
(12) Patent Application Publication
(10) Pub. No.: US 2004/0028235 A1
(43) Pub. Date: Feb. 12, 2004

(54) Audio control pattern apparatus

(76) Inventor: Deson Pan, Taichung City (TW)

Correspondence Address: BIRCH STEWART KOLASCH & BIRCH, PO BOX 747, FALLS CHURCH, VA, 22040-0747, US

(21) Appl. No.: 10/212,109

(22) Filed: Aug. 6, 2002

(51) Int. Cl. H04R 29/00

(52) U.S. Cl. 381/56

(57) ABSTRACT

An audio control pattern apparatus includes at least one audio receiver, a signal processing circuit and at least one pattern display device which consists of a pattern control chip and a pattern display unit. When in use, the audio receiver receives audio signals to drive the signal processing circuit. The signals are output to the pattern control chip to actuate and conduct light emitting diodes (LEDs) or light conducting tubes of the pattern display device to display patterns in a layer fashion. The apparatus of the invention may be adopted for use on shoes or package boxes or luminous ornaments.

### FIELD OF THE INVENTION

The present invention relates to a pattern display apparatus and particularly an audio control pattern apparatus that controls pattern display by sound and beat.

### BACKGROUND OF THE INVENTION

Many household goods such as shoes, package boxes, refrigerators and electric appliances are covered by various patterns for the purpose of promotion, warning, appealing to consumers or simply to be more attractive. Take shoes for instance, the profile of a shoe is generally very simple. However in order to attract customers, some shoes for children are designed as dancing shoes that can generate sound or display patterns. Most shoes with such a design now available on the market have a plurality of light emitting diodes (LEDs) arranged in straight lines. When the shoes are worn and pound on the ground surface, the impact or vibration actuates the LEDs to become conductive and generate light. Such a design can only display in a simple way. It cannot meet consumers' requirements in the high technology era we are living today.

### SUMMARY OF THE INVENTION

Therefore the primary object of the invention is to provide a pattern display apparatus that controls preset pattern display in a layer fashion by sound according to a selected sequence.

Another object of the invention is to provide a pattern display apparatus adopted for use on package boxes or luminous ornaments to increase added value.

The apparatus of the invention has a display area for a preset pattern formed by LEDs or light conducting tubes. And an audio control means is employed to activate the LEDs according to a selected sequence so that the patterns may be displayed in a layer fashion.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram for the audio control pattern apparatus of the invention.

FIG. 2 is a circuit diagram of a signal process circuit of the invention.

FIG. 3 is a pictorial view of the invention adopted on a shoe.

### DESCRIPTION OF THE PREFERRED EMBODIMENT

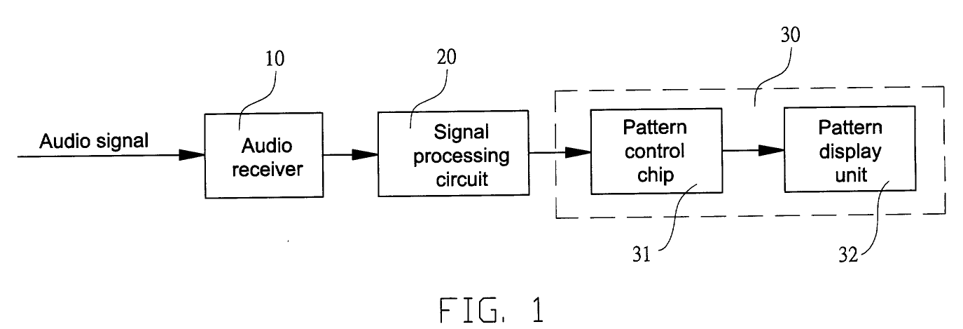

Referring to FIG. 1, the audio control pattern apparatus of the invention includes at least one audio receiver 10, a signal processing circuit 20 and at least one pattern display device 30. The audio receiver 10 may be a capacitor microphone for receiving audio signals. The signal processing circuit 20 receives the audio signals from the audio receiver 10 and includes a plurality of comparison circuits and at least one output end. The pattern display device 30 connects to the output end of the signal processing circuit 20 and includes a pattern control chip 31 and a pattern display unit 32 which has a plurality of light emitting diodes (LEDs) or light conducting tubes arranged according to a preset pattern. When in use, the audio receiver 10 receives sound and beat signals and drives the signal processing circuit 20. The comparison circuits of the signal processing circuit 20 process the signals and outputs the signals through different output ends to the pattern control chip 31 of the pattern display device 30. The pattern control chip 31 has output ends to conduct the LEDs to display the pattern in a layer fashion. Display is done by the pattern display unit 32 and is controlled by the pattern control chip 31 through a firmware design.

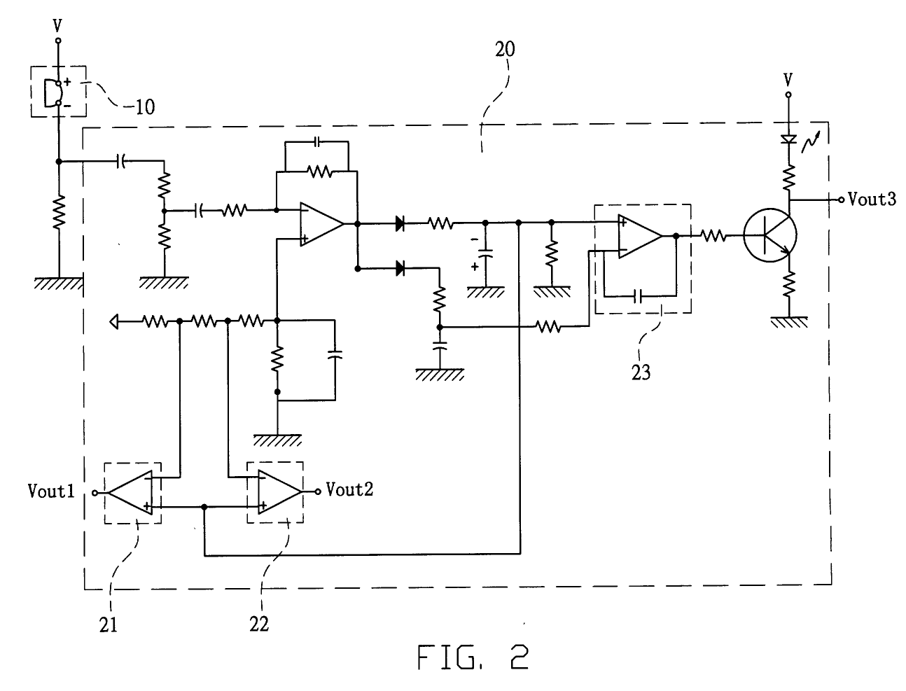

Refer to FIG. 2 for an embodiment of the invention. The audio control pattern apparatus includes a capacitor microphone audio receiver 10, a signal processing circuit 20 and at least one pattern display device 30. The signal processing circuit 20 includes a high voltage comparison circuit 21, a medium voltage comparison circuit 22 and a low voltage comparison circuit 23. Each comparison circuit 21, 22 and 23 has a corresponding output end Vout1, Vout2 and Vout3. The comparison circuit 21, 22 or 23 includes a plurality of resistors and a voltage comparison means. The configuration of the resistors can change the reference voltage of the voltage comparison means. The pattern display device 30 includes a pattern control chip 31 and a pattern display unit 32. The output ends Vout1, Vout2 and Vout3 connect to the pattern control chip 31, and through the pattern control chip 31 and different control signals to control pattern display of the pattern display unit 32. In this embodiment the pattern display unit 32 is a star-shaped pattern display area 32A which consists of a plurality of LEDs and light conducting tubes. Each set of the LEDs is connected to the output end of the pattern control chip 31. The star-shaped pattern display area 32A includes a circle 321, a plurality of V shapes 322 and a plurality of diagonal lines 323. When the audio receiver 10 receives audio signals and beat of different volume, the audio signals are transferred to the signal processing circuit 20 and transformed to different voltage signals. The comparison circuits 21, 22 and 23 compare the signals and deliver output signals to the pattern display device 30 through different output ends. Then the pattern control chip 31 drives and conducts sequentially the LEDs of the star-shaped pattern display area 32A in the pattern display unit 32 to display the pattern.

In addition, the comparison circuit compares the input voltage value and the reference voltage value, and decides the output voltage. As the invention has a plurality of comparison circuits of different reference voltages, it can accept different voltages and deliver outputs at different output ends. Hence the output ends of the signal processing circuit 20 may be directly linked to the pattern display unit 32. Moreover, as each output end is connected to LEDs of a different pattern, the LEDs of each pattern may be displayed in a layer fashion. Taken the aforesaid embodiment for example, the LEDs for the circle pattern 321 are connected to the output end Vout1 of the high voltage comparison circuit 21, the LEDs for the V-shaped pattern 322 are connected to the output end Vout2 of the medium voltage comparison circuit 22, and the LEDs for the diagonal lines 323 are connected to the output end Vout3 of the low voltage comparison circuit 23.

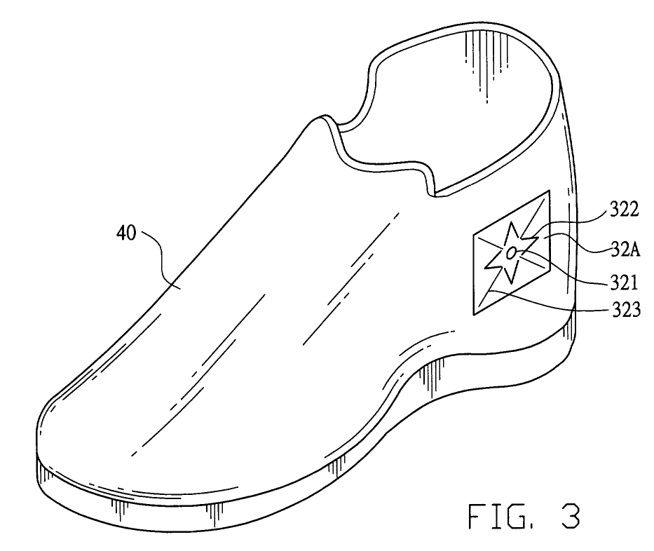

The audio control pattern apparatus of the invention may be adopted for use on package boxes or luminous ornaments or dancing shoes. Refer to FIGS. 1 and 3 for an embodiment of adopting the invention to a shoe. The shoe includes at least a shoe body 40, at least one audio receiver 10, one signal processing circuit 20 and at least one pattern display device 30. The audio received 10 may be a capacitor microphone and is installed on the shoe body 40. The signal processing circuit 20 is installed on the shoe body 40 for receiving audio signals from the audio receiver 10 and includes a plurality of comparison circuits and at least one output end. The comparison circuits include a plurality of resistors and a voltage comparison means. The configuration of the resistors can change the reference voltage of the voltage comparison means. There is also a pattern display device 30 consisting of a pattern control chip 31 and a pattern display unit 32 located on the shoe body 40 and connecting to the output end of the signal processing circuit 20. The pattern display device 30 has a plurality of light emitting diodes (LEDs) or light conducting tubes arranged according to a preset pattern. Each set of the LEDs or light conducting tubes are controlled by the pattern control chip 31. The audio receiver 10 on the shoe body 40 receives sound and beat signals and drives the signal processing circuit 20, and outputs through the output end to conduct the LEDs to display the pattern in a layer fashion. Furthermore, the preset pattern may be formed by multiple LEDs. And each set of the LEDs is connected to one output end of the signal processing circuit 20 so that the pattern display unit 32 may be controlled by hardware to display in a layer fashion.

What is claimed is:

1. An audio control pattern apparatus, comprising:
at least one audio receiver;
a signal processing circuit for receiving audio signals from the audio receiver including a plurality of comparison circuits and at least one output end; and
at least one pattern display device connected to the output end of the signal processing circuit including a pattern display unit which consists of a plurality of light emitting diodes (LEDs) or light conducting tubes arranging according to a preset pattern;
wherein the audio receiver receives the audio signals and drives the signal processing circuit to deliver output through the output end to conduct the LEDs to display the pattern.

2. The audio control pattern apparatus of claim 1, wherein the audio receiver is a capacitor microphone.

3. The audio control pattern apparatus of claim 1, wherein the comparison circuits include a plurality of resistors and a voltage comparison means.

4. The audio control pattern apparatus of claim 3, wherein the voltage comparison means has a reference voltage which is changeable by the configuration of the resistors.

5. The audio control pattern apparatus of claim 1, wherein the preset pattern includes a plurality sets of LEDs, each set of the LEDs being connected to one output end of the signal processing circuit.

6. The audio control pattern apparatus of claim 1, wherein the pattern display device includes a pattern control chip for controlling display of the pattern display unit.

7. An audio control pattern apparatus for use on a shoe, comprising:
a shoe body;
at least one audio receiver located on the shoe body;
a signal processing circuit located on the shoe body for receiving audio signals from the audio receiver including a plurality of comparison circuits and at least one output end; and
at least one pattern display device located on the shoe body and connected to the output end of the signal processing circuit including a pattern display unit which consists of a plurality of light emitting diodes (LEDs) or light conducting tubes arranging according to a preset pattern;
wherein the audio receiver receives the audio signals and drives the signal processing circuit to deliver output through the output end to conduct the LEDs to display the pattern.

8. The audio control pattern apparatus of claim 7, wherein the audio receiver is a capacitor microphone.

9. The audio control pattern apparatus of claim 7, wherein the comparison circuits include a plurality of resistors and a voltage comparison means.

10. The audio control pattern apparatus of claim 9, wherein the voltage comparison means has a reference voltage which is changeable by the configuration of the resistors.

11. The audio control pattern apparatus of claim 7, wherein the preset pattern includes a plurality sets of LEDs, each set of the LEDs being connected to one output end of the signal processing circuit.

12. The audio control pattern apparatus of claim 7, wherein the pattern display device includes a pattern control chip for controlling display of the pattern display unit.
